(19) United States
(12) Patent Application Publication
(10) Pub. No.: US 2018/0116350 A1
(43) Pub. Date: May 3, 2018

(54) PARACORD JIG

(71) Applicants: Eric Buteau, Many, LA (US); Susan Buteau, Many, LA (US)

(72) Inventors: Eric Buteau, Many, LA (US); Susan Buteau, Many, LA (US)

(21) Appl. No.: 15/340,171

(22) Filed: Nov. 1, 2016

(51) Int. Cl. A44C 27/00; B25B 11/02; A44C 5/18

(52) U.S. Cl. CPC A44C 27/00; A44C 5/18; B25B 11/02

(57) ABSTRACT

A jig for fabricating bracelets that includes: a first octagon wheel mounted on a first anchor; a second octagon wheel mounted on a second anchor; a first spindle extending through the first octagon wheel; a second spindle extending through the second octagon wheel; scale extending between the first anchor and the second anchor; and a buckle attachment means on each outer side of both the first octagon wheel and the second octagon wheel. The scale preferably includes an adjusting knob. The first octagon wheel and second octagon wheel both include a center opening adapted to accommodate the first spindle on the first octagon wheel and the second spindle on the second octagon wheel.

### BACKGROUND OF THE INVENTION

### Field of Invention

The present invention relates to a jig used to create multiple bracelets.

### Description of Related Art

Handmade bracelets are made by craftsmen through a tedious process. Bracelet making includes various tools that are used to create the components of the bracelet and attachment of buckles for connection purposes. The entire process can be time-consuming and proper support equipment is necessary to create multiple bracelets in a timely manner. It is particularly important to attach the buckles to the ends of the bracelets once the interior creation is set. Most jigs used to attach the buckles simply aren't available. As a result, it would be advantageous to have a jig that's capable of creating multiple bracelets in a timely manner where the jig is arranged to create up to eight bracelets through a rotation process.

### SUMMARY OF THE INVENTION

The present invention relates to a jig for fabricating bracelets that includes: a first octagon wheel mounted on a first anchor; a second octagon wheel mounted on a second anchor; a first spindle extending through the first octagon wheel; a second spindle extending through the second octagon wheel; scale extending between the first anchor and the second anchor; and a buckle attachment means on each outer side of both the first octagon wheel and the second octagon wheel. The scale preferably includes an adjusting knob. The first octagon wheel and second octagon wheel both include a center opening adapted to accommodate the first spindle on the first octagon wheel and the second spindle on the second octagon wheel.

### BRIEF DESCRIPTION OF DRAWINGS

FIG. 1 depicts a prospective view of a multiple-bracelet jig in accordance with the present invention.

FIG. 2 depicts an octagon wheel used in accordance with the present invention.

### DETAILED DESCRIPTION

The present invention relates to a jig created to facilitate the attachment of buckles to multiple bracelets through the use of an octagon wheel arrangement. The jig includes a pair of octagon wheels mounted on spindles, which are supported by two anchors. Below the octagon wheels is a scale with an adjusting knob that helps the user to adjust the jig setup in accordance with the bracelet design. Buckles will attach along an outer surface of the octagon wheel and then may rotate to effectively connect the buckles on each end of a bracelet.

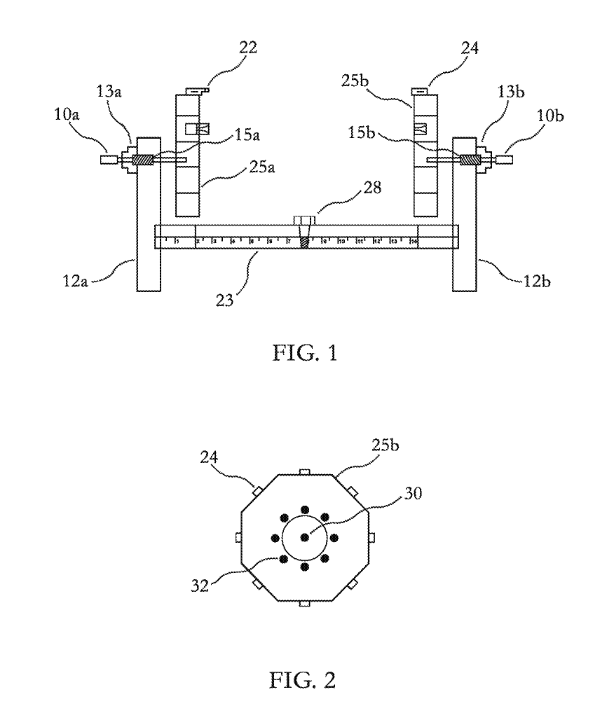

In reference to FIG. 1, a jig according to the present invention is depicted. This jig includes the Anchors 12a, 12b at each end of the jig. A Scale 23 is extending between the Anchors 12a, 12b that includes an Adjusting Knob 28. The Scale 23 is used to adjust the positioning of a bracelet between two Rotating Octagon Wheels 25a, 25b. Each octagon wheel 25a, 25b is mounted on a spindle. Octagon Wheel 25a is mounted on Spindle 10a and on the opposing side is Octagon Wheel 25b mounted on Spindle 10b. The spindles 10a, 10b transfer through an opening on each respective Anchor 12a, 12b. As can be seen Spindle 10a extends through a Bracket 13a and includes a Bearing 15a through the Anchor 12a. On the inside of Anchor 12a, Spindle 10a extends and supports Octagon Wheel 25a. Further and similarly Octagon Wheel 25b is mounted on Spindle 10b, where Spindle 10b extends through Bracket 13b and includes Bearing 15b. Buckle Holders are along each outer surface of the Rotating Wheels 25a, 25b so Buckle Holder 22 is shown on the Wheel 25a and similarly Buckle Holder 24 is shown on Wheel 25b.

A side view of Wheel 25b is shown in FIG. 2. As shown Wheel 25b includes eight sides with Buckle Holder 24 mounted on each respective side. Wheel 25a is configured similarly although not shown. An Opening 30 is provided at the center of the wheel that receives the Spindle 10b for mounting onto Anchor 12b. A series of holes 32 extend around the Opening 30 therefore creating the support for the Rotating Wheel 25b. This jig is created to speed the creation of bracelets and aids in the uniform and precise creation of each bracelet through the effective use of multiple buckle supports. The instant invention has been shown and described in what it considers to be the most practical and preferred embodiments. It is recognized, however, that departures may be made there from within the scope of the invention and that obvious modifications will occur to a person skilled in the art.

What is claimed is:

1. A jig for fabricating bracelets comprising:
a. a first octagon wheel mounted on a first anchor;
b. a second octagon wheel mounted on a second anchor;
c. a first spindle extending through the first octagon wheel;
d. a second spindle extending through the second octagon wheel;
e. scale extending between the first anchor and the second anchor; and
f. a buckle attachment means on each outer side of both the first octagon wheel and the second octagon wheel.

2. The jig according to claim 1, where the scale includes an adjusting knob.

3. The jig according to claim 1, where both the first octagon wheel and second octagon wheel include a center opening adapted to accommodate the first spindle on the first octagon wheel and the second spindle on the second octagon wheel.

4. The jig according to claim 1, where the first spindle includes a bracket and bearing.

5. The jig according to claim 1, where the second spindle includes a bracket and bearing.
